(19) United States
(12) Patent Application Publication
(10) Pub. No.: US 2024/0156073 A1
(43) Pub. Date: May 16, 2024

(54) SONAR REFLECTIVE FISHING TACKLE

(71) Applicant: LAKE WATER LLC, Auburn, AL (US)

(72) Inventor: Robert V. Terrell, Auburn, AL (US)

(21) Appl. No.: 18/508,607

(22) Filed: Nov. 14, 2023

Related U.S. Application Data
(60) Provisional application No. 63/425,203, filed on Nov. 14, 2022.

(51) Int. Cl. A01K 83/00; G01S 15/74; G01S 15/96

(52) U.S. Cl. CPC A01K 83/00; G01S 15/74; G01S 15/96

(57) ABSTRACT

A fishing tackle device including a body configured to be drawn through the water and an attachment point configured to connect to a fishing line from a fishing platform (e.g., a boat, dock, or shoreline). The fishing tackle device further includes a sonar reflector affixed to the body. The sonar reflector is configured to receive sonar waves from and direct sonar waves back toward a transducer of a fish finder on the boat.

### CROSS-REFERENCE TO RELATED APPLICATIONS

This application is a non-provisional application of and hereby claims priority to U.S. Provisional Patent Application No. 63/425,203 entitled “SONAR REFLECTIVE FISHING TACKLE”, filed on Nov. 14, 2022.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FEDERALLY SPONSORED RESEARCH AND DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to fishing tackle. More particularly, this invention pertains to the interaction between fish finders (i.e., consumer sonar devices) and fishing tackle.

Fish finders were originally down-firing sonar transceivers designed for deep water fishing. They were used to detect fish or structure directly under the boat. This was particularly useful in deep water offshore fishing. Consumer sonar devices have evolved to include side-scan technologies which are useful in shallow and moderate depth waters to quickly find structure and fish. Now, directional sonar systems can be directed by the user to look through shallow water at structure that is being inspected for fish. These systems are most useful in shallow freshwater lakes and rivers where fish typically strike on relatively small baits and tackle. These baits and tackle rarely show up on sonar systems until a fisherman has retrieved the bait almost back to the boat.

### BRIEF SUMMARY OF THE INVENTION

Aspects of the present invention provide fishing tackle device that is sonar reflective. The fishing tackle device is a lure or attachment that goes at the bait end of a fishing line. When a fisherman throws the bait into the water and begins retrieving it via a reel, a sonar reflector of the device reflects sonar waves from a transducer of a fish finder on the fisherman's boat back at the boat and therefore back at the transducer of the fish finder. This improves the visible range of the fishing tackle over the prior art such that the fishing tackle device can be seen by directional sonar systems when interacting with fish.

In one aspect, a fishing tackle device includes a body configured to be drawn through the water. The fishing tackle device further includes an attachment point configured to connect to a fishing line from a fishing platform (e.g., boat or dock). The fishing tackle device further includes a sonar reflector affixed to the body. The sonar reflector is configured to receive sonar waves from and direct sonar waves back toward a transducer of a fish finder on the fishing platform.

In another aspect, a fishing tackle device includes a body, wherein the body is a crankbait body, a bill extending outwardly and forwardly from the crankbait body, and an attachment point located on the bill. The attachment point is configured to connect to a fishing line. The fishing tackle device further includes a sonar reflector on the crankbait body. The sonar reflector is configured to receive and direct sonar waves toward a transducer of a fish finder in a boat from which the fishing line emanates.

In another aspect, a fishing tackle device includes a lure configured to be pulled through the water toward a boat by a fishing line from the boat. The lure comprises a sonar reflector configured to direct sonar waves emanating from the boat back at the boat.

### BRIEF DESCRIPTION OF THE DRAWINGS

FIG. 1 is a schematic view of a fish finder and a prior art lure, illustrating how the prior art lure scatters the sonar waves and therefore is difficult to detect by the fish finder.

FIG. 2 is a schematic view of a fish finder and a sonar reflecting fishing tackle device in accordance with an embodiment of the invention, illustrating how the sonar reflecting fishing tackle device directs the sonar waves toward the transducer of the fish finder.

FIG. 3 is a perspective view of the sonar reflecting fishing tackle device of FIG. 2. The sonar reflecting fishing tackle device includes a jig head with a parabolic reflector according to one embodiment of the invention.

FIG. 4 is a side schematic view of the sonar reflecting fishing tackle device of FIGS. 2-3.

FIG. 5 is a perspective view of another embodiment of a sonar reflecting fishing tackle device. The sonar reflecting fishing tackle device includes a jig head with a parabolic and perpendicular reflector.

FIG. 6 is a side schematic view of the sonar reflecting fishing tackle device of FIG. 5.

FIG. 7 is a perspective view of another embodiment of a sonar reflecting fishing tackle device. The sonar reflecting fishing tackle device includes a jig head with a plurality of parabolic reflectors.

FIG. 8 is a side schematic view of the sonar reflecting fishing tackle device of FIG. 7.

FIG. 9 is a perspective view of another embodiment of a sonar reflecting fishing tackle device. The sonar reflecting fishing tackle device includes a jig head with a conical reflector.

FIG. 10 is a side schematic view of the sonar reflecting fishing tackle device of FIG. 9.

FIG. 11 is a perspective view of another embodiment of a sonar reflecting fishing tackle device. The sonar reflecting fishing tackle device includes a jig head with a conical and perpendicular reflector.

FIG. 12 is a side schematic view of the sonar reflecting fishing tackle device of FIG. 11.

FIG. 13 is a perspective view of another embodiment of a sonar reflecting fishing tackle device. The sonar reflecting fishing tackle device includes a jig head with a shallow parabolic reflector.

FIG. 14 is a side schematic view of the sonar reflecting fishing tackle device of FIG. 13.

FIG. 15 is a perspective view of another embodiment of a sonar reflecting fishing tackle device. The sonar reflecting fishing tackle device includes a jig head with a flat reflector.

FIG. 16 is a side schematic view of the sonar reflecting fishing tackle device of FIG. 15.

FIG. 17 is a perspective view of another embodiment of a sonar reflecting fishing tackle device. The sonar reflecting fishing tackle device includes a jig head with an oval parabolic reflector.

FIG. 18 is a side schematic view of the sonar reflecting fishing tackle device of FIG. 17.

FIG. 19 is a perspective view of another embodiment of a sonar reflecting fishing tackle device. The sonar reflecting fishing tackle device includes an ellipsoidal jig head with a parabolic reflector.

FIG. 20 is a side schematic view of the sonar reflecting fishing tackle device of FIG. 19.

FIG. 21 is a perspective view of another embodiment of a sonar reflecting fishing tackle device. The sonar reflecting fishing tackle device includes a jig head with a grooved reflector.

FIG. 22 is a side schematic view of the sonar reflecting fishing tackle device of FIG. 21.

FIG. 23 is a perspective view of another embodiment of a sonar reflecting fishing tackle device. The sonar reflecting fishing tackle device includes a teardrop shaped jig head with a parabolic reflector.

FIG. 24 is a side schematic view of the sonar reflecting fishing tackle device of FIG. 23.

FIG. 25 is a top view of another embodiment of a sonar reflecting fishing tackle device. The sonar reflecting fishing tackle device includes an umbrella rig with a conical reflector.

FIG. 26 is an end view of the sonar reflecting fishing tackle device of FIG. 25.

FIG. 27 is a perspective view of another embodiment of a sonar reflecting fishing tackle device. The sonar reflecting fishing tackle device is in the form of a crankbait that includes a crankbait body with a parabolic reflector.

FIG. 28 is a side view of the sonar reflecting fishing tackle device of FIG. 27.

FIG. 29 is a perspective view of another embodiment of a sonar reflecting fishing tackle device. The sonar reflecting fishing tackle device includes a truncated jig head and a flat reflector.

FIG. 30 is a side view of the sonar reflecting fishing tackle device of FIG. 29.

FIG. 31 is a front view of the sonar reflecting fishing tackle device of FIG. 29.

FIG. 32 is a top view of the sonar reflecting fishing tackle device of FIG. 29.

FIG. 33 is a bottom view of the sonar reflecting fishing tackle device of FIG. 29.

FIG. 34 is a perspective view of another embodiment of a sonar reflecting fishing tackle device. The sonar reflecting fishing tackle device includes a tomahawk jig head and a sonar reflector.

FIG. 35 is a side view of the sonar reflecting fishing tackle device of FIG. 34.

FIG. 36 is a front view of the sonar reflecting fishing tackle device of FIG. 34.

FIG. 37 is a top view of the sonar reflecting fishing tackle device of FIG. 34.

FIG. 38 is a bottom view of the sonar reflecting fishing tackle device of FIG. 34.

FIG. 39 is a perspective view of another embodiment of a sonar reflecting fishing tackle device. The sonar reflecting fishing tackle device includes a jig head and a plurality of sonar reflectors.

FIG. 40 is a side view of the sonar reflecting fishing tackle device of FIG. 39.

FIG. 41 is a front view of the sonar reflecting fishing tackle device of FIG. 39.

FIG. 42 is a top view of the sonar reflecting fishing tackle device of FIG. 39.

FIG. 43 is a bottom view of the sonar reflecting fishing tackle device of FIG. 39.

FIG. 44 is a perspective view of another embodiment of a sonar reflecting fishing tackle device. The sonar reflecting fishing tackle device includes a jig head and a sonar reflector connected to the jig head.

FIG. 45 is a side view of the sonar reflecting fishing tackle device of FIG. 44.

FIG. 46 is a front view of the sonar reflecting fishing tackle device of FIG. 44.

FIG. 47 is a cross-sectional view of the sonar reflecting fishing tackle device, taken along line 47-47 of FIG. 46.

FIG. 48 is a top view of the sonar reflecting fishing tackle device of FIG. 44.

FIG. 49 is a bottom view of the sonar reflecting fishing tackle device of FIG. 44.

FIG. 50 is a perspective view of another embodiment of a sonar reflecting fishing tackle device. The sonar reflecting fishing tackle device comprises a split shot tackle device.

FIG. 51 is a side view of the sonar reflecting fishing tackle device of FIG. 50.

FIG. 52 is a front view of the sonar reflecting fishing tackle device of FIG. 50.

FIG. 53 is a top view of the sonar reflecting fishing tackle device of FIG. 50.

FIG. 54 is a bottom view of the sonar reflecting fishing tackle device of FIG. 50.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. As described herein, the upright position of a fishing tackle device is when being pulled through the water via an attachment point of the device such that the rear end is following the forward end of the device. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

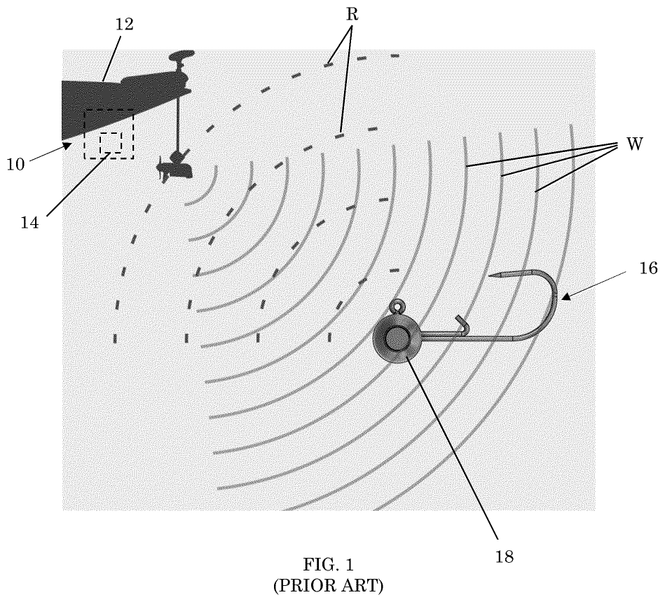

Referring to FIG. 1, there is shown a schematic view of a sonar system in the form of a fish finder 10. The fish finder 10 is on a fishing platform (e.g., fishing boat 12) and generally includes a display screen (not shown), a controller with a processor (not shown), and a transducer 14 configured to send and receive sonar waves W to detect fish or other objects. Fishing platform is used interchangeably herein with boat or docket, and boats, docks, and other places from which people fish are fishing platforms within the scope of the claims. A prior art lure 16 is difficult or impossible to detect, especially beyond 15 ft (4.5 m) beyond the boat, because its rounded body 16, e.g., circular jig head 16, disperses the sonar waves W from the fish finder 10 in all directions, as illustrated by the arced phantom lines W in FIG. 1.

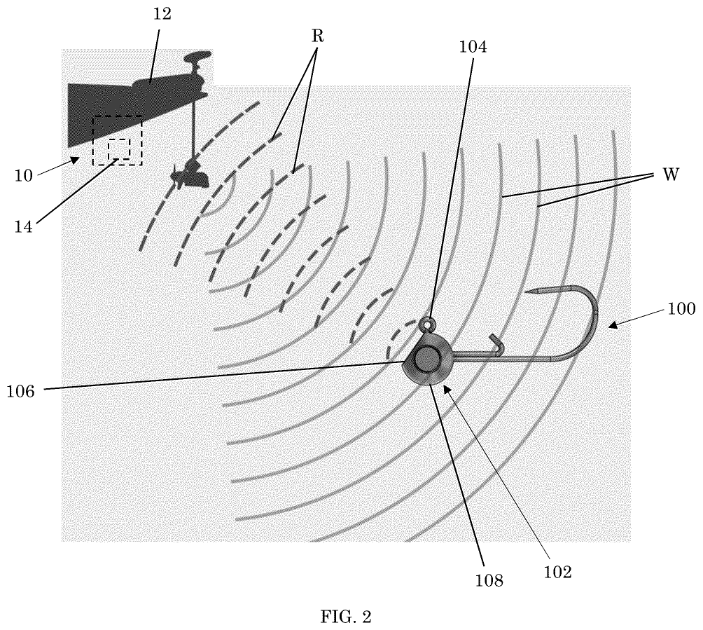

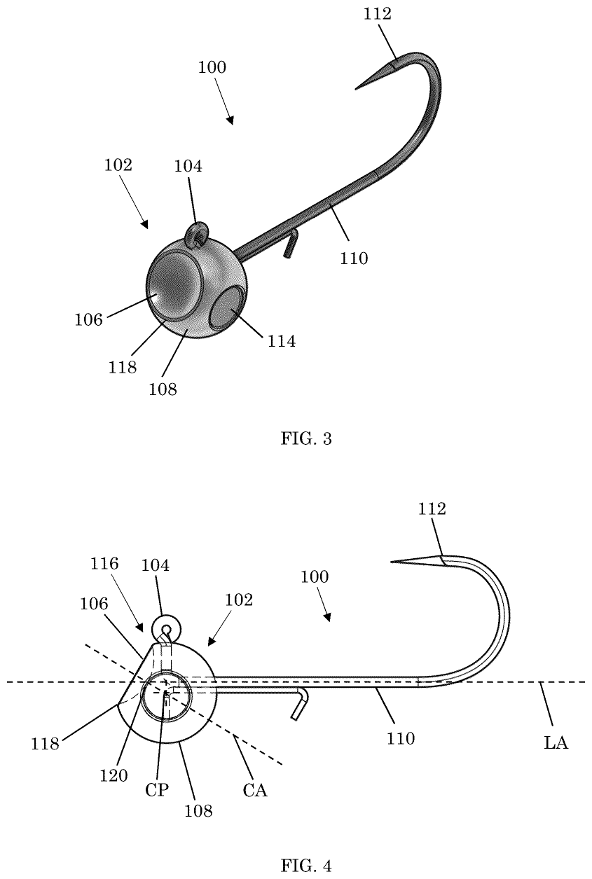

Referring to FIGS. 2-4, there is shown an embodiment of a sonar reflecting fishing tackle device 100 that is configured to direct sonar waves R back toward the fishing platform (e.g., boat 12), and thereby toward the transducer 14 of the fish finder 10, such that the fishing tackle device 100 is easy to find and locate by the fish finder 10. The fishing tackle device 100 can be configured as a lure, or attachment thereto, that goes at the bait end of a fishing line. The fishing tackle device 100 includes a body 102, an attachment point 104, and a sonar reflector 106 for gathering, focusing, and reflecting the sonar waves R (i.e., sonar returns or reflections) back to the transducer 14 on the boat 12.

When a fisherman throws the fishing tackle device 100 into the water and begins retrieving it via a reel, the sonar reflector 106 reflects the sonar waves R back at the boat 12, and therefore back at the sonar transceiver 14. This improves the detectability, i.e., visible range, of the fishing tackle device 100 as compared to the prior art lure 16. For instance, the fishing tackle device 100 can be readily detected by any desired fish finder 10 well beyond 15 ft (4.5 m) from the transducer 14, making the fishing tackle device 100 easily identifiable in shallow or deep water. This increased range and visibility is a significant improvement over prior art lures, which typically cannot be seen well, or at all, unless and until the lure is within a close proximity, such as 5-10 ft (1.5-3 m) from transducer 14 on the boat 12.

The body 102 generally includes a head 108, such as a jig head 108, a shank 110 extending outwardly and rearwardly from the head 108, and a hook 112. A center point CP of the head 108 can be located vertically underneath a longitudinal axis LA of the shank 110. The body 102 can further include side indents 114 which are coaxial to the center point CP of the body 102. The head 108 can have any desired material, size, and weight. For instance, the head 108 can be a 5 oz (14.2 kg) jig head comprised of metal. A swimbait or other lure body, mimicking a worm or small fish, can be added onto the body 102.

The attachment point 104 and the sonar reflector 106 can be affixed to a forward end 116 of the head 108 of the body 102 (FIG. 4). Additionally, the attachment point 104 and the sonar reflector 106 can be integral with the body 102. The attachment point 104 is configured to connect to a fishing line. The attachment point, as used herein, may connect to the fishing line via a swivel or quick connect within the scope of the claims. The attachment point 104 can be in the form of an eye. The eye can be integrally formed with the shank 110 and the hook 112 and extend through the head 108 at a 90 degree angle, such that a center point of the eye is aligned with the center point CP of the head 108 of the body 102. Alternatively, in another embodiment, the eye may not be perpendicularly oriented to the shank 110, and thereby may define a non-perpendicular angle relative to the shank 110.

The sonar reflector 106 is configured to direct sonar waves W from an origin of the fishing line (e.g., the fishing platform or the boat 10 on which a fisherman is standing and is equipped with a directional sonar device) generally along the fishing line back at the origin. In other words, the sonar reflector 106 gathers, focuses, and reflects the sonar waves R back to the transducer 14 of the fish finder. Hence, the sonar reflector 106 allows the fishing tackle device 100 to be more easily detected and at greater distances, further away from the transducer 14 as compared to prior art lures 16. Therein, the fishing tackle device 100 will appear bigger and brighter on the display screen of the fish finder 10 as compared to prior art lures 16 which may appear dimmer, smaller, or may not appear at all on the display screen.

As shown, the sonar reflector 106 is a concave dish 106 which extends into the body 102 from an outer edge 118 of the body 102 to an apex 120. The apex 120 defines the deepest point that the concave dish 106 extends within the body 102. The sonar reflector 106 is non-perpendicular to the to the longitudinal axis LA as defined by the shank 110. A center axis CA extending through the center point or apex 120 of the sonar reflector 106 can be non-parallel to the longitudinal axis LA. The center axis CA is normal to a plane tangent to the center point or apex 120 of the sonar reflector 106. The center axis can extend upwardly from the longitudinal axis LA at a 30 degree angle relative thereto. The apex 120 can be in line with the longitudinal axis LA such that the longitudinal axis LA extends through the apex 120. Alternatively, the apex 120 of the sonar reflector 106 can be located vertically underneath the longitudinal axis LA. The diameter of the sonar reflector 106 can be less than the diameter (or widest point) of the head 108 of the body 102. The diameter of the sonar reflector 106 can be 65% of the diameter of the head 108, plus or minus 25%. For example, the diameter of the sonar reflector 106 can be 0.3 in. (8 mm) and the diameter of the head 108 can be 0.5 in. (14 mm).

The sonar reflector 106 automatically focuses and directs the sonar waves R to the boat 12. The sonar reflector 106 is located next to and underneath the attachment point 104. Hence, due to the shape of the sonar reflector 106 and the position of the sonar reflector 106 on the body 102 and relative to the attachment point, the sonar reflector 106 will automatically point toward the boat 12, and transducer 14 thereon, when the body 102 is drawn through the water, and the fishing line acts against the attachment point 104. Since the sonar reflector 106 is located at the forward end 116 of the body 102, and its apex 120 is located above the center point CP of the head of the body 102 and above the longitudinal axis LA of the shank 110, the sonar reflector 106 will face the boat 12 during use. Additionally, the structure of the sonar reflector 106 itself assists in orienting the sonar reflector 106 toward the boat 12 because as the body 102 is drawn through the water, the sonar reflector 106 will receive incoming water and dispense the water radially outward from its apex 120, which in combination with its position and the forces acting on the attachment point 104, will continually point the apex 120 toward the boat 12 (both forward and upward toward the boat 12). It should be understood that the sonar reflector 106 “points toward” the boat 12 in that the sonar reflector 106 is generally directed upwardly and forwardly, oriented along the fishing line from its attachment point 104 to its origin on the boat 12, as the body 102 is drawn through the water.

In other embodiments, the sonar reflector 106 can be configured to have a concave, parabolic, conical, conical frustrum, pyramidal, cylindrical, or flat design. The fishing tackle device 100 can include only one sonar reflector or multiple sonar reflectors. The fishing tackle device 100 can be configured to accommodate various bait types or categories of baits. For example, the fishing tackle device 100 can be configured as a swimbait jig head, a jig, a wobble head jig, a crankbait, a jerk bait, an A-rig or umbrella rig, a trap, a soft bait with plastic inserts, a hair jig, an under spin, split shot weight, or a bullet weight tackle device.

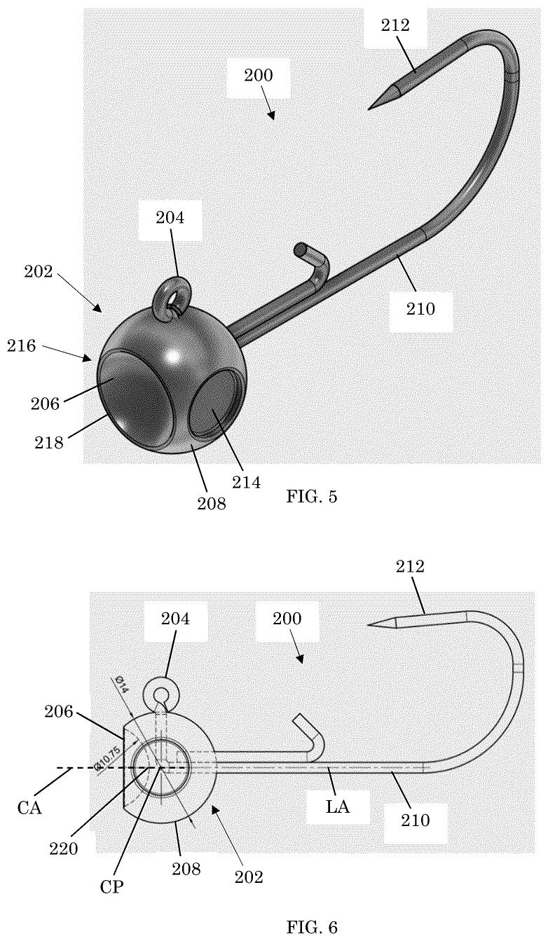

Referring now to FIGS. 5-6, there is shown another embodiment of a sonar reflecting fishing tackle device 200, which can be substantially similar to the sonar reflecting fishing tackle device 100 of FIGS. 2-4, except that the sonar reflector 206 is configured as a parabolic reflector 206 that is oriented perpendicular to and coaxial with the longitudinal axis LA. The sonar reflector 206 also points forwardly only instead of both forwardly and upwardly as does the sonar reflector 106. The center axis CA extending through the apex 220 of the sonar reflector 206 can be parallel to and/or coaxial with the center point CP of the head 208 of the body 202 and the longitudinal axis LA of the shank 210. The sonar reflector 206 can be larger than the sonar reflector 106 as discussed above. For example, the diameter of the sonar reflector 206 can be 0.4 in. (10.75 mm) and the diameter of the head 208 can be 0.5 in. (14 mm). Like elements have been identified with like reference characters, except for the 200 series designation.

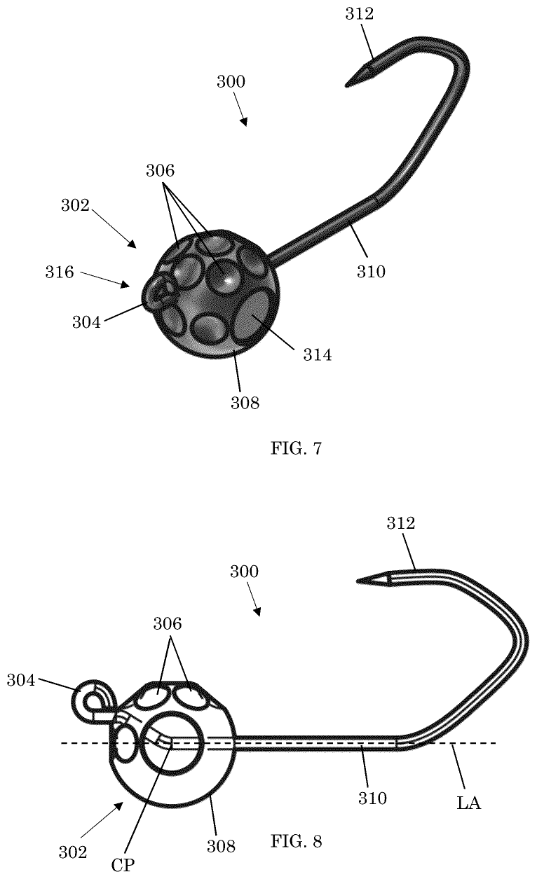

Referring now to FIGS. 7-8, there is shown another embodiment of a sonar reflecting fishing tackle device 300, which can be substantially similar to the sonar reflecting fishing tackle device 100 of FIGS. 2-4, except that the sonar reflector 300 comprises a plurality of parabolic reflectors 306 that are located on the front and top of the head 308 of the body 302. The parabolic reflectors 306 may or may not be identical to one another. Three parabolic reflectors 306 can be located at the front and center of the head 308. Seven parabolic reflectors 306 can be located at the top of the head 308. The attachment point 304 can be located at the forward end 316 of the head 308, such as at a 30 degree angle from the shank 310 instead of a 90 degree angle. The plurality of parabolic reflectors 306 can surround the attachment point 304. Like elements have been identified with like reference characters, except for the 300 series designation.

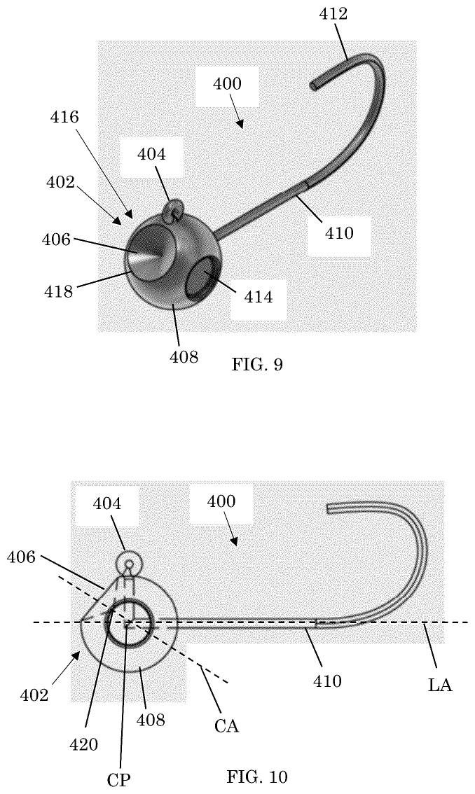

Referring now to FIGS. 9-10, there is shown another embodiment of a sonar reflecting fishing tackle device 400, which can be substantially similar to the sonar reflecting fishing tackle device 100 of FIGS. 2-4, except that the sonar reflector 406 is configured as a conical reflector. As shown, the sonar reflector 406 is a conical dish 406. Like elements have been identified with like reference characters, except for the 400 series designation.

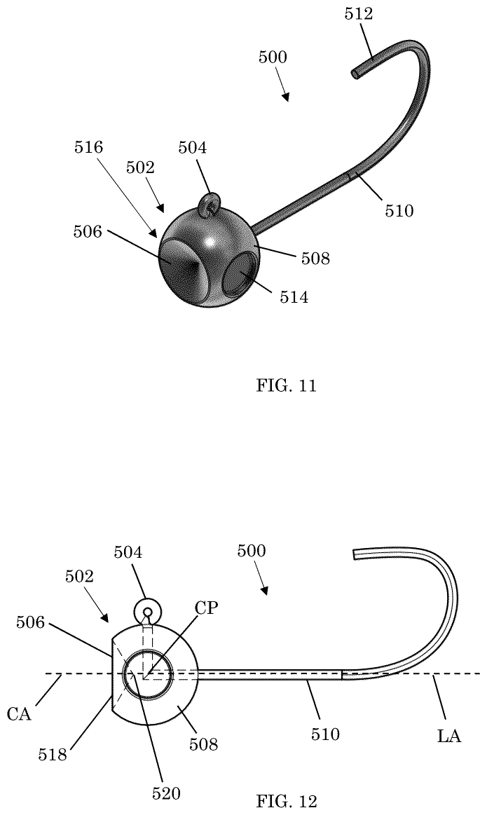

Referring now to FIGS. 11-12, there is shown another embodiment of a sonar reflecting fishing tackle device 500, which can be substantially similar to the sonar reflecting fishing tackle device 400 of FIGS. 9-10, except that the sonar reflector 506 is configured as a conical dish 506 which is oriented perpendicular to and coaxial with the longitudinal axis LA of the shank 510. In other words, the center axis CA extending through the apex 520 can be parallel to and/or coaxial with the longitudinal axis LA. Therein, a plane of the open end of the conical dish 506 is perpendicular to the longitudinal axis LA of the shank 510. Like elements have been identified with like reference characters, except for the 500 series designation.

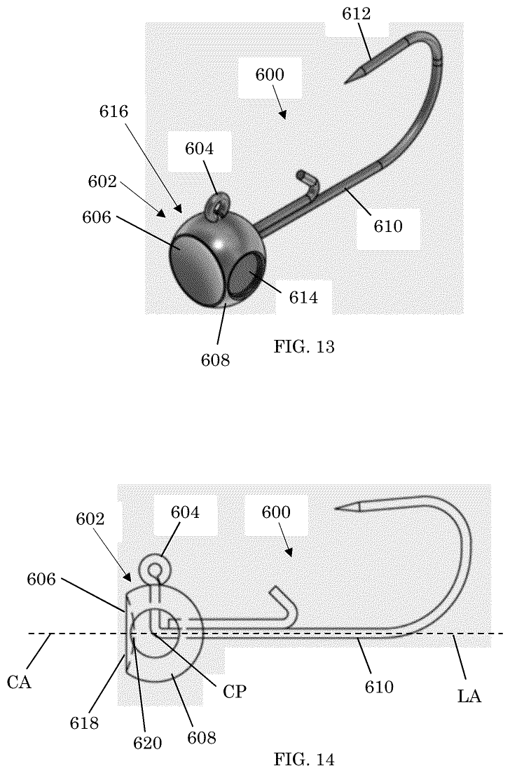

Referring now to FIGS. 13-14, there is shown another embodiment of a sonar reflecting fishing tackle device 600, which can be substantially similar to the sonar reflecting fishing tackle device 200 of FIGS. 5-6, except that the sonar reflector 606 is shallower such that the apex 620 thereof does not extend as far into the body 602 as in the embodiment of FIGS. 5-6. Like elements have been identified with like reference characters, except for the 600 series designation.

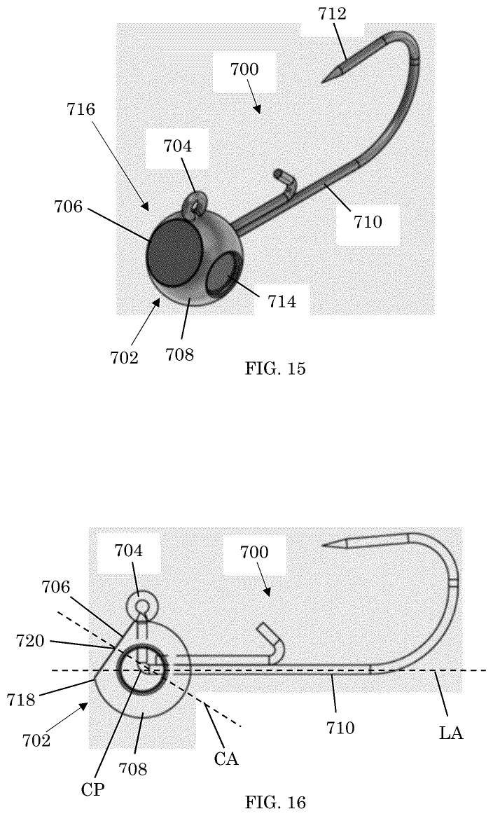

Referring now to FIGS. 15-16, there is shown another embodiment of a sonar reflecting fishing tackle device 700, which can be substantially similar to the sonar reflecting fishing tackle device 100 of FIGS. 2-4, except that the sonar reflector 706 is configured as a flat reflector 706. The flat sonar reflector 706 can be planar such that it defines an outer flat wall of the head 708 of the body 702. The flat sonar reflector 706 can be non-perpendicular to the longitudinal axis LA of the shank 710. In other words, the center axis CA of a center point 720 of the flat sonar reflector 702 can be non-perpendicular to the longitudinal axis LA Like elements have been identified with like reference characters, except for the 700 series designation.

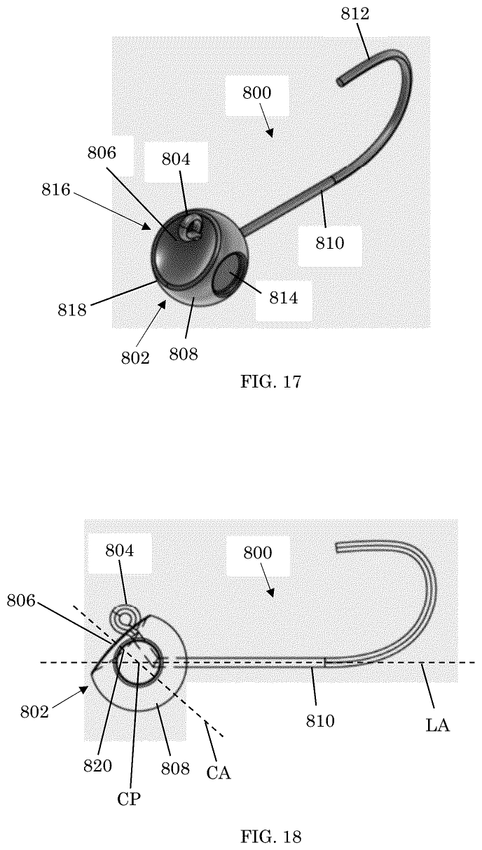

Referring now to FIGS. 17-18, there is shown another embodiment of a sonar reflecting fishing tackle device 800, which can be substantially similar to the sonar reflecting fishing tackle device 100 of FIGS. 2-4, except that the sonar reflector 808 is configured as an oval parabolic reflector 808. The sonar reflector 808 can have an annular circumference and an oval or ellipsoidal concavity which directs the sonar waves R toward the transducer 14 on the boat 12.

The attachment point 804 can be located within the sonar reflector 806 and extend outwardly therefrom. In other words, the sonar reflector 806 can surround the attachment point 804. Therein, the sonar reflector 806 and the attachment point 804 can together be oriented toward the boat 12. The angle of the attachment point 804, e.g., the stem of the eye, may be oriented obtuse relative to the longitudinal axis of the shank 810, at an angle of approximately 120 degrees, plus or minus 20 degrees. In other words, the attachment point 804 can extend upwardly and forwardly away from the shank 810 at an angle of approximately 30 degrees, plus or minus 20 degrees, as viewed from the front end of the fishing tackle device 800. The sonar reflector 806 can have the same angle of the attachment point 804 relative to the shank 810. In other words, the angle of a reference line extending through the apex 820 toward the shank 810 can match the angle of the attachment point relative to the shank 810. The attachment point 804 can be located vertically above the apex 820 of the sonar reflector 806. Like elements have been identified with like reference characters, except for the 800 series designation.

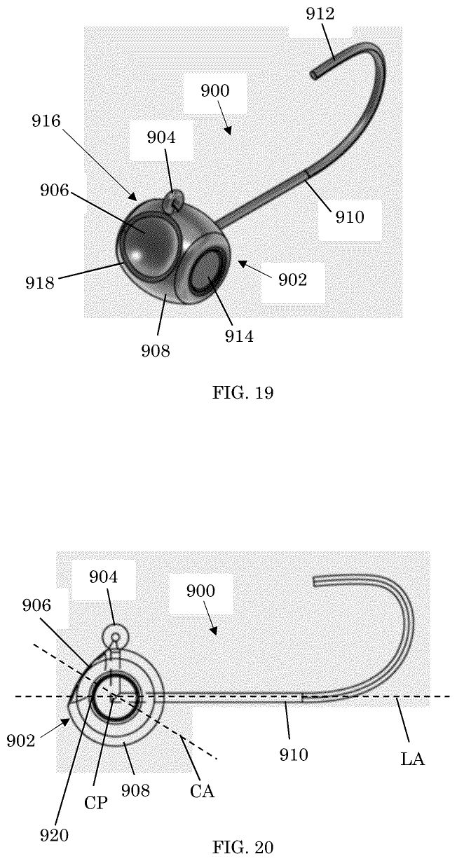

Referring now to FIGS. 19-20, there is shown another embodiment of a sonar reflecting fishing tackle device 900, which can be substantially similar to the sonar reflecting fishing tackle device 100 of FIGS. 2-4, except that the sonar reflecting fishing tackle device 900 includes an ellipsoidal jig head 908 with a parabolic reflector 906. Like elements have been identified with like reference characters, except for the 900 series designation.

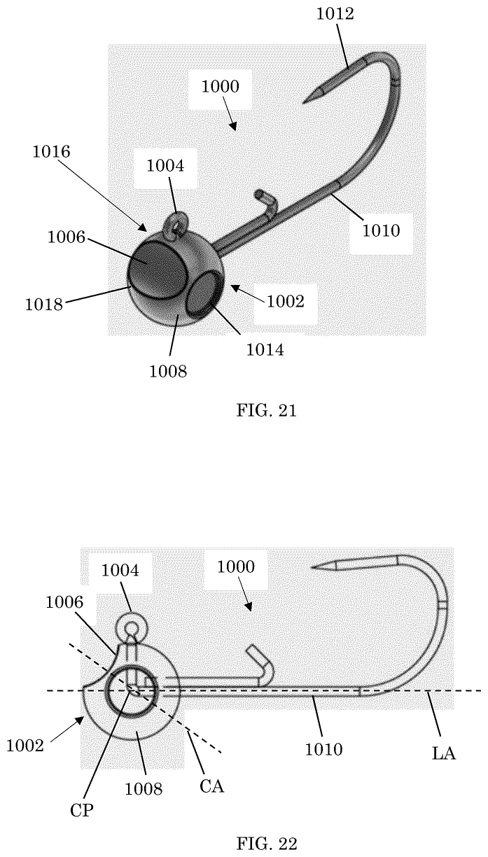

Referring now to FIGS. 21-22, there is shown another embodiment of a sonar reflecting fishing tackle device 1000, which can be substantially similar to the sonar reflecting fishing tackle device 100 of FIGS. 2-4, except that the sonar reflector 1006 is configured as a grooved reflector 1006. The jig head 1008 has an ellipsoidal cutout therein which forms the sonar reflector 1006. The sonar reflector 1006 is not shaped like a dish but rather an open groove or channel in the top and forward quadrant of the jig head 1008. Like elements have been identified with like reference characters, except for the 1000 series designation.

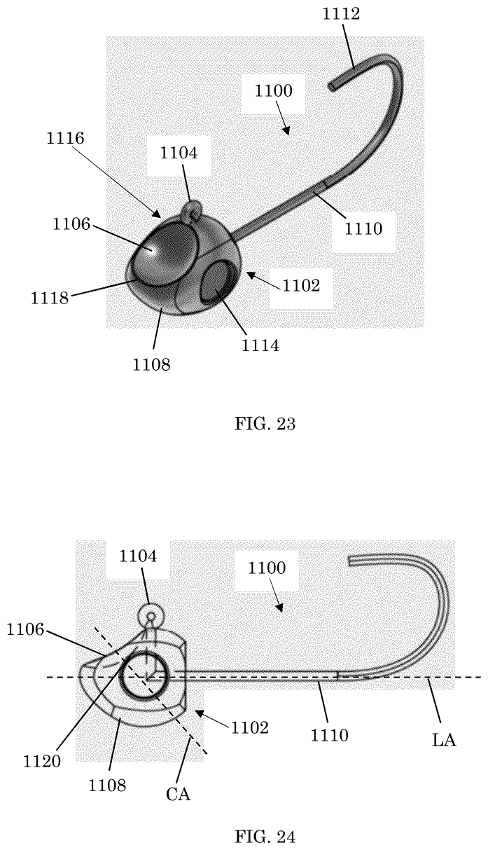

Referring now to FIGS. 23-24, there is shown another embodiment of a sonar reflecting fishing tackle device 1100, which can be substantially similar to the sonar reflecting fishing tackle device 100 of FIGS. 2-4, except that the sonar reflecting fishing tackle device 1100 includes a teardrop shaped jig head 1108 and a parabolic sonar reflector 1106. As shown in FIG. 24, the side profile of the jig head 1108 is shaped like a teardrop. In other words, the jig head 1108 is generally bulbous in shape. Therein, the jig head 1108 is widest at its center and narrows to a forward end point. Like elements have been identified with like reference characters, except for the 1100 series designation.

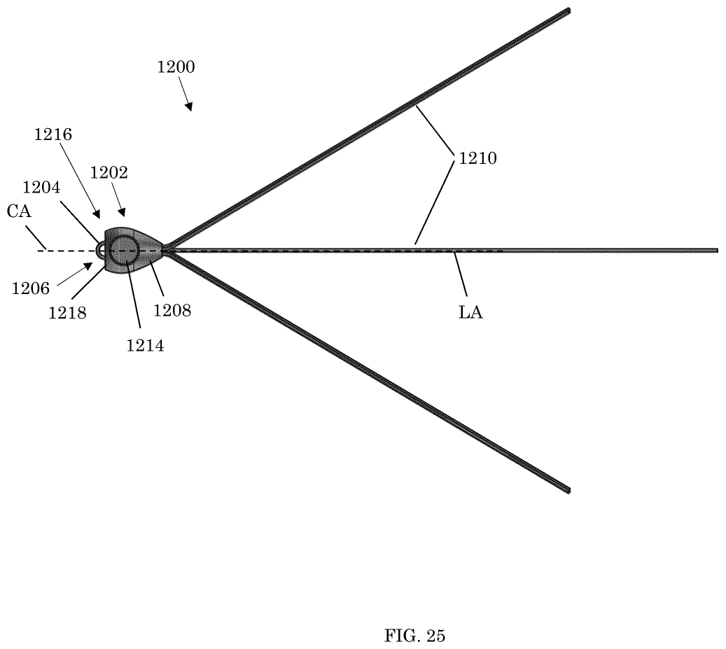

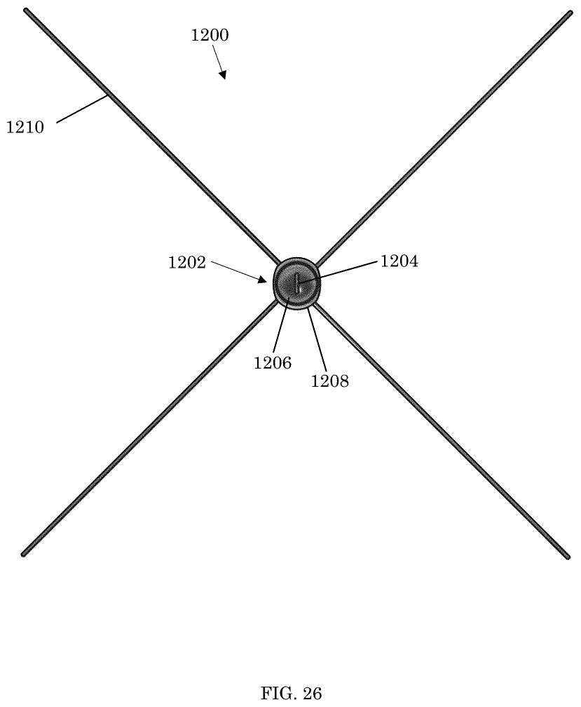

Referring now to FIGS. 25-26, there is shown another embodiment of a sonar reflecting fishing tackle device 1200, which can be substantially similar to the sonar reflecting fishing tackle device 100 of FIGS. 2-4, except that the sonar reflecting fishing tackle device 1200 includes a body 1202 in the form of an umbrella rig 1202 with a conical reflector 1206. The umbrella rig 1202 generally includes a jig head 1208, an attachment point 1204, a plurality of wires 1210, and a plurality of swimbaits connected to the wires 1210 for mimicking a school of baitfish (not shown). The attachment point 1204 is coaxial with the longitudinal axis LA, which extends through the center of the jig head 1208 and the center wire 1210. The sonar reflector 1206 is located at the forward end 1216 of the jig 1208 and is oriented perpendicular to and coaxial with the longitudinal axis LA. In other words, a center axis extending through an apex or center point of the sonar reflector 1206 can parallel to and/or coaxial with the longitudinal axis LA. The sonar reflector 1206 surrounds the attachment point 1204. Like elements have been identified with like reference characters, except for the 1200 series designation.

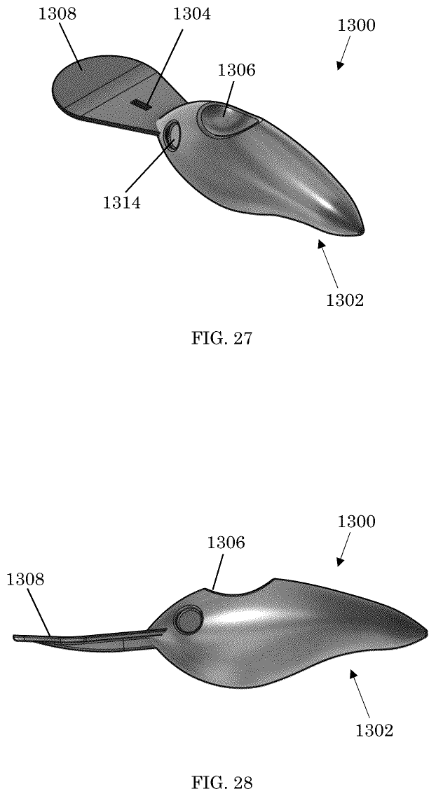

Referring now to FIGS. 27-28, there is shown another embodiment of a sonar reflecting fishing tackle device 1300 which is configured as a crankbait 1300 that includes a crankbait body 1302, a bill 1308, an attachment point 1304 located on the bill 1308, and a parabolic sonar reflector 1306 located at the top of the crankbait body 1302. The attachment point 1304 can be an eye or a through hole in the bill 1308. The sonar reflector 1306 is a conical dish 1306 integrally formed in the crankbait body 1302. The sonar reflector 1306 can be located on the top of the crankbait body 1302, rearwardly of the attachment point 1304. Thereby, when the crankbait body 1302 is drawn through the water, and the fishing line acts on the attachment point 1304, the sonar reflector 1306 will oscillate and face upwardly and forwardly toward the boat 12. The sonar reflector 1306 can be substantially similar to the sonar reflector 106 as shown in FIGS. 2-4.

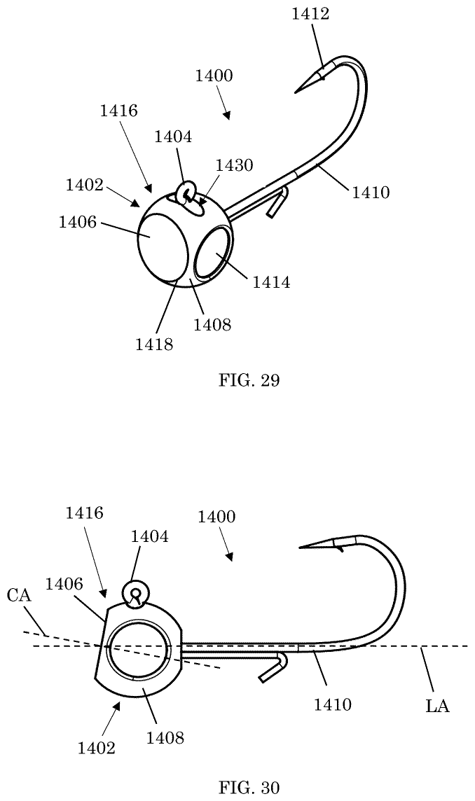

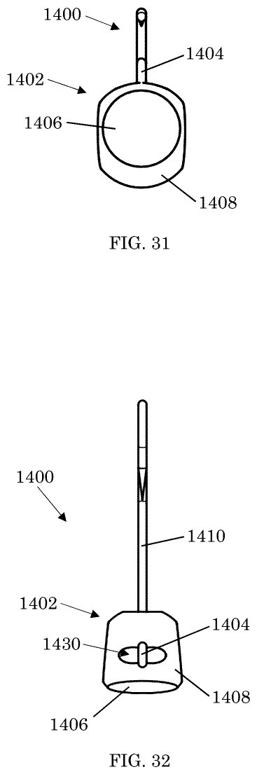

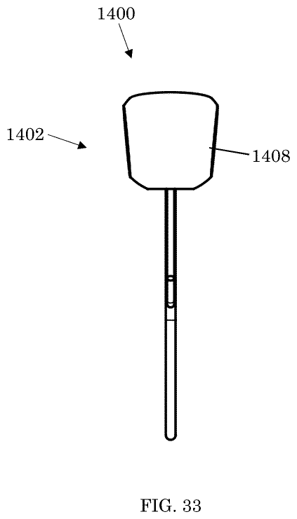

Referring now to FIGS. 29-33, there is shown another embodiment of a sonar reflecting fishing tackle device 1400, which can be substantially similar to the sonar reflecting fishing tackle device 100 of FIGS. 2-4, except that the sonar reflecting fishing tackle device 1400 includes a truncated jig head 1408 and a flat sonar reflector 1406. The truncated jig head 1408 has a forward end with an angled and flat surface that comprises the integrated sonar reflector 1406, a rearward end that is flat and oriented perpendicularly to the longitudinal axis LA of the shank 1410, and angled side walls extending in between the forward and rearward ends. Like elements have been identified with like reference characters, except for the 1400 series designation.

The attachment point 1404 can be seated within an open channel 1430. The open channel 1430 can have an ellipsoidal cross-section. In some embodiments, the open channel 1430 can serve as a second sonar reflector 1430 which thereby ensures that the sonar waves R will be reflected back toward the boat 12 at the forward end 1416 of the body 1402, via the first sonar reflector 1406, and at the top of the body 1402, via the second sonar reflector 1430. Therein, even when the body 1402 oscillates back and forth, tilting up and down, relative to the fishing line, the reflectors 1406, 1430 will direct the sonar waves R toward the boat 12.

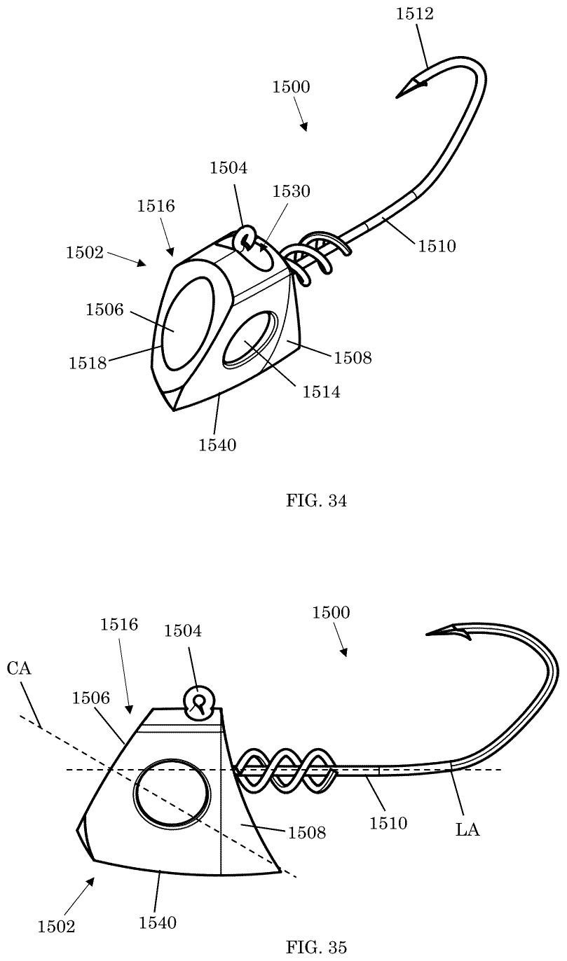

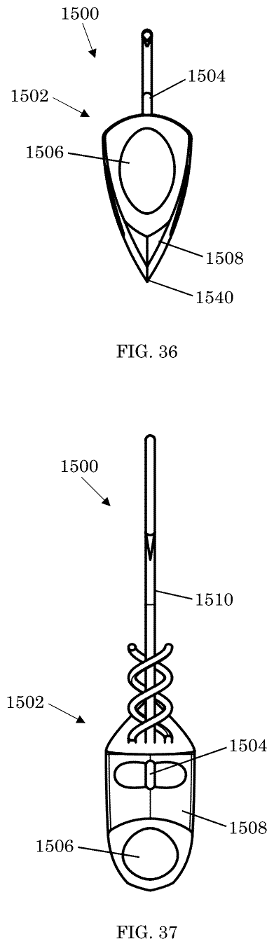

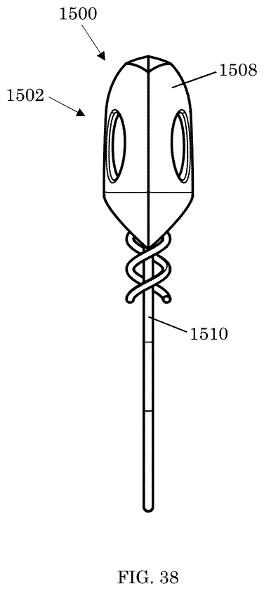

Referring now to FIGS. 34-38, there is shown another embodiment of a sonar reflecting fishing tackle device 1500, which can be substantially similar to the sonar reflecting fishing tackle device 100 of FIGS. 2-4, except that the sonar reflecting fishing tackle device 1500 includes a tomahawk jig head 1508 and a sonar reflector 1506 located at the forward end thereof. The body 1502 has a shape which generally corresponds to a blade of a tomahawk or axe. The body 1502 is wider at its top end and tapers toward a bottom blade edge 1540. The sonar reflector 1506 can be a parabolic, conical, or flat reflector. The attachment point 1504 can be seated within an open channel 1530. In some embodiments, the open channel 1530 can serve as a second sonar reflector 1530. Like elements have been identified with like reference characters, except for the 1500 series designation.

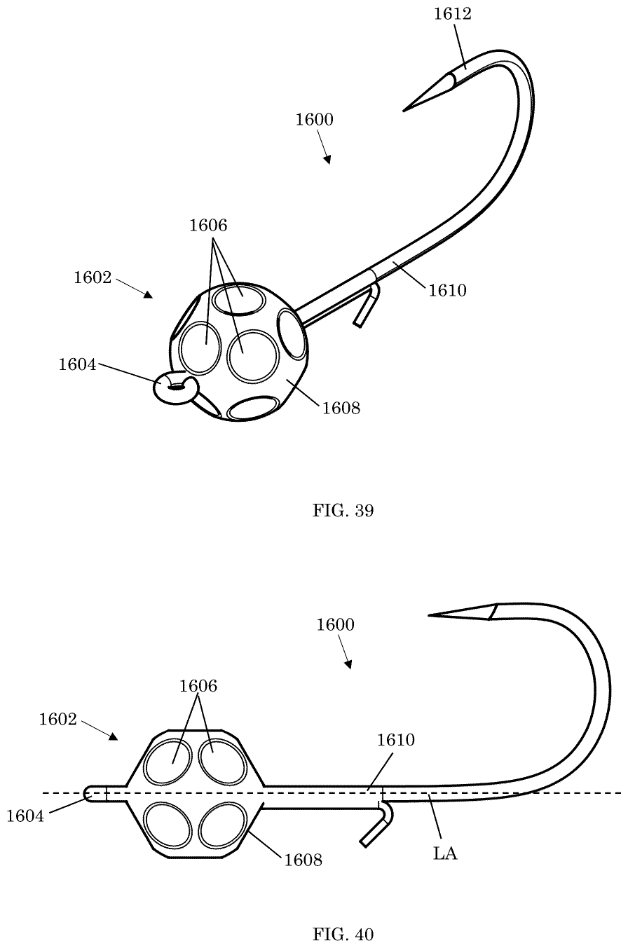

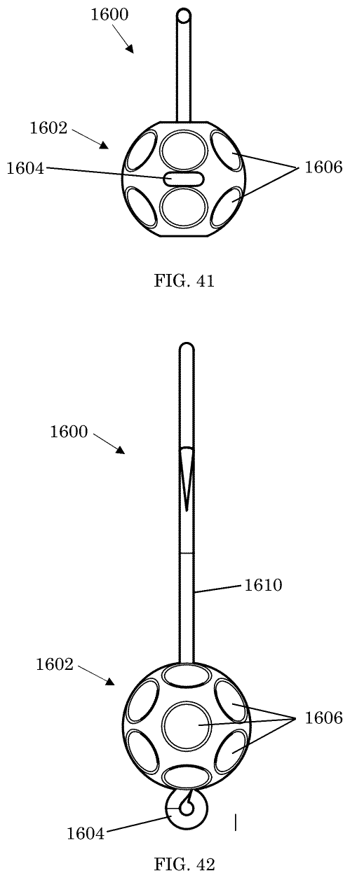

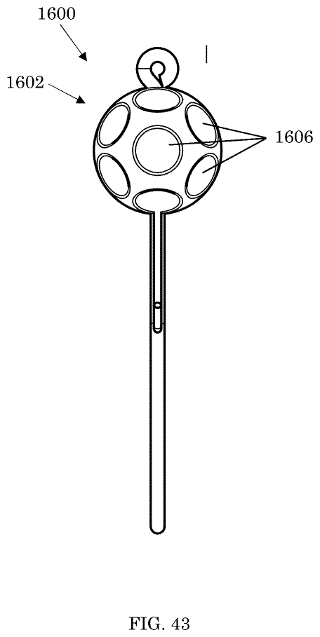

Referring now to FIGS. 39-43, there is shown another embodiment of a sonar reflecting fishing tackle device 1600, which can be substantially similar to the sonar reflecting fishing tackle device 100 of FIGS. 2-4, except that the sonar reflecting fishing tackle device 1600 includes a jig head 1608 and a plurality of sonar reflectors 1606 surrounding the top, bottom, front, and back of the jig head 1608. Like elements have been identified with like reference characters, except for the 1600 series designation.

The plurality of sonar reflectors 1606 may or may not be identical to one another. Each sonar reflector 1606 can be a parabolic, conical, or flat reflector. As shown, each reflector 1606 is a parabolic reflector. In operation, the plurality of sonar reflectors 1606 will reflect the sonar waves R back toward the boat 12 whether or not the fishing line is taut and pulling upwardly on the attachment point 1604. In other words, the top, bottom, front, and back sonar reflectors 1606 will ensure that the sonar waves R are directed back to the boat 12 in any orientation of the sonar reflecting fishing tackle device 1600, e.g., upside down, pointing downwardly, or backwards. The attachment point 1604 can be parallel to and coaxial with the longitudinal axis LA of the shank 1610.

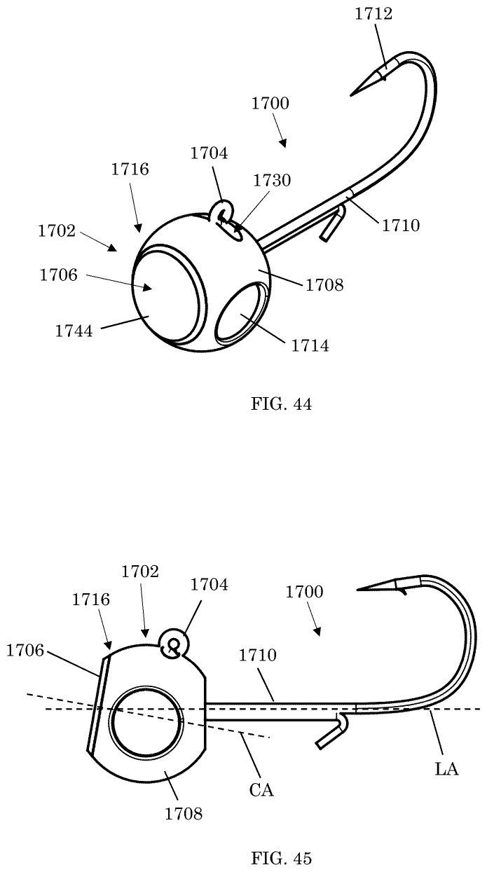

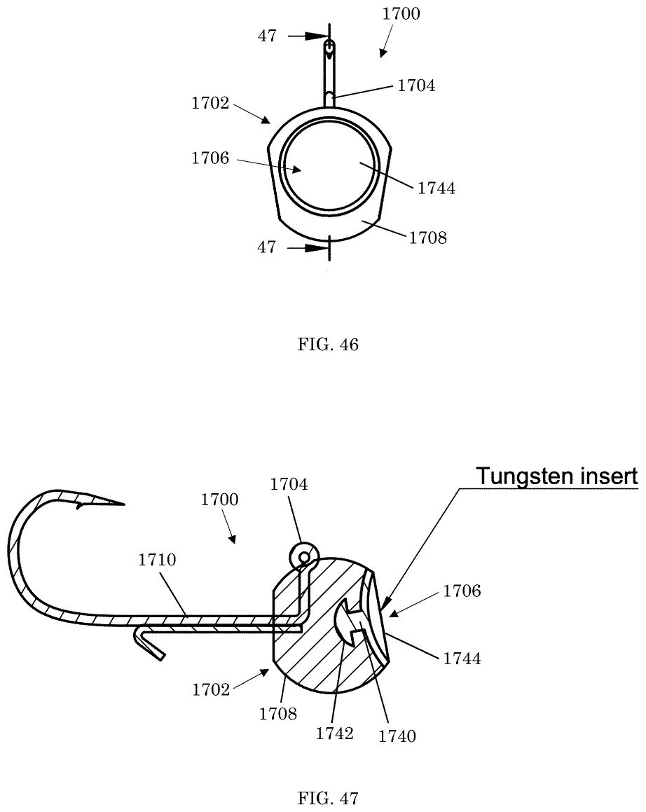

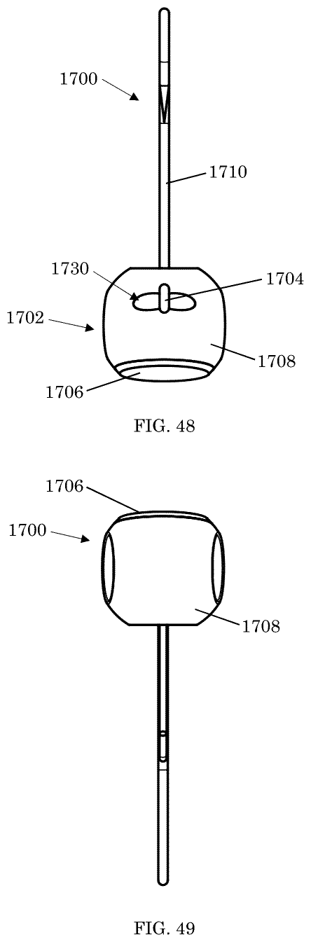

Referring now to FIGS. 44-49, there is shown another embodiment of a sonar reflecting fishing tackle device 1700, which can be substantially similar to the sonar reflecting fishing tackle device 100 of FIGS. 2-4, except that the sonar reflecting fishing tackle device 1600 includes a separately formed and insertable sonar reflector 1706. The attachment point 1704 can be seated within an open channel 1730. In some embodiments, the open channel 1730 can serve as a second sonar reflector 1730. Like elements have been identified with like reference characters, except for the 1700 series designation.

The sonar reflector 1706 can be an insert that connects to the forward end 1716 of the body 1702. Specifically, as shown in FIG. 47, a mating head 1740 extending outwardly from the rear of the sonar reflector 1706 fits within and locks into a corresponding recess 1742 in the body 1702 of the jig head 1708. The mating head 1740 comprises a stem and a mushroom head, however the mating head 1740 can be variously configured within the scope of the claims. The forward end 1744 of the sonar reflector 1706, opposite the mating head 1740, can comprise a parabolic dish, conical dish, a dimpled surface, or a flat surface. The forward end 1744 of the sonar reflector 1706 can sit flush with the body 1702 and define an end cap that extends outwardly beyond the body 1702. The sonar reflector 1706 can be comprised of any desired material, such as metal. For example, the sonar reflector 1706 can be made of tungsten.

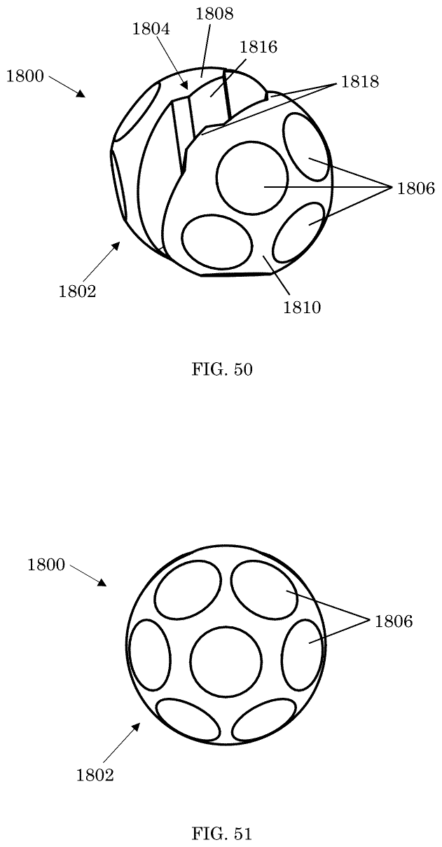

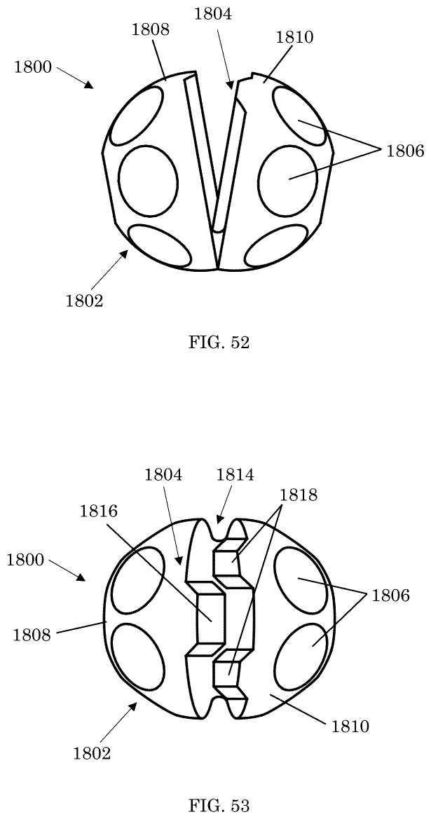

Referring now to FIGS. 50-54, there is shown another embodiment of a sonar reflecting fishing tackle device 1800 in the form of a split shot 1800. The sonar reflecting fishing tackle device 1800 can serve as a weight that is selectively attachable to the fishing line or onto a portion of another fishing tackle device. The sonar reflecting fishing tackle device 1800 generally includes a body 1802, an attachment point 1804, and a plurality of sonar reflectors 1806 spaced about the body 1802.

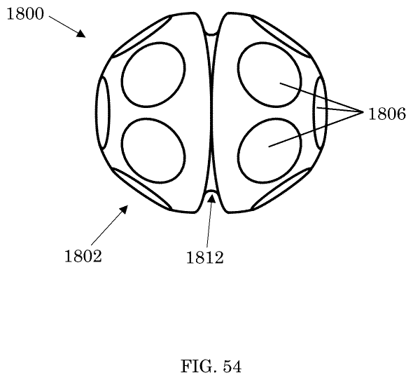

The body 1804 is a split body with left and right portions 1808, 1810 connected to one another at their bottom end, which defines a bottom seam 1812 (FIG. 54). In the present embodiment, and within the scope of the claims, the attachment point 1804 is the point at which the body 1804 couples to a fishing line or a fishing tackle device. Referring specifically to FIG. 53, the attachment point 1804 comprises an open mouth 1814 between the body portions 1808, 1810 and opposing and corresponding protrusions 1816, 1818 which extend outwardly from the inside faces of each body portion 1808, 1810. To connect the body 1804 to a fishing line, the user can position the fishing line within the open mouth 1814 and clamp the body portions 1808, 1810 together, thereby securing the fishing line between the protrusions 1816, 1818.

The plurality of sonar reflectors 1806 may be spaced about the outer periphery of each body portion 1808, 1810. The plurality of sonar reflectors 1806 may or may not be identical to one another. Each sonar reflector 1806 can be a parabolic, conical, or flat reflector. As shown, each reflector 1806 is a parabolic reflector.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful SONAR REFLECTIVE FISHING TACKLE it is not intended that such references be construed as limitations upon the scope of this invention except as set forth in the following claims.

What is claimed is:

1. A fishing tackle device comprising:
a body configured to be drawn through the water;
an attachment point configured to connect to a fishing line from a fishing platform; and
a sonar reflector affixed to the body, the sonar reflector is configured to receive sonar waves from and direct sonar waves back toward a transducer of a fish finder on the fishing platform.

2. The fishing tackle device of claim 1, wherein:
the body has a forward end;
the sonar reflector is affixed to the forward end of the body;
the attachment point is at the forward end of the body;
the sonar reflector is located underneath the attachment point at the forward end of the body;
the fishing platform is a boat; and
the sonar reflector is configured to point toward the boat, and also thereby toward the transducer of the fish finder on the boat.

3. The fishing tackle device of claim 1, wherein:
the sonar reflector is a concave portion of the body.

4. The fishing tackle device of claim 1, wherein:
the attachment point and sonar reflector are integral with the body.

5. The fishing tackle device of claim 1, wherein:
the sonar reflector is a concave dish.

6. The fishing tackle device of claim 1, wherein:
the sonar reflector is a concave dish at the forward end of the body.

7. The fishing tackle device of claim 1, wherein:
the body includes a jig head; and
the sonar reflector is integral with the jig head.

8. The fishing tackle device of claim 1, wherein:
the body is a crankbait body.

9. The fishing tackle device of claim 1, wherein:
the sonar reflector is metal.

10. The fishing tackle device of claim 1, wherein:
the sonar reflector is a conical dish.

11. The fishing tackle device of claim 1, wherein:
the sonar reflector is a groove in the forward end of the body.

12. The fishing tackle device of claim 1, wherein:
the sonar reflector is a flat reflector that defines a flat wall at the forward end of the body.

13. The fishing tackle device of claim 1, wherein:
the body includes a teardrop shaped jig head.

14. The fishing tackle device of claim 1, wherein:
the body further includes a shank defining a longitudinal axis; and
a center axis extending through an apex or center of the sonar reflector is non-parallel to the longitudinal axis.

15. The fishing tackle device of claim 1, wherein:
the body further includes a shank defining a longitudinal axis; and
a center axis extending through an apex or center of the sonar reflector is parallel to the longitudinal axis.

16. The fishing tackle device of claim 1, wherein:
the body further includes a shank defining a longitudinal axis;
the sonar reflector is perpendicular to the longitudinal axis;
the sonar reflector is concave and extends into the body from an outer edge of the body to an apex; and
a center axis extending through the apex is coaxial to the longitudinal axis.

17. The fishing tackle device of claim 1, wherein:
the attachment point is located within the sonar reflector.

18. The fishing tackle device of claim 1, wherein:
the attachment point is in the form of an eye.

19. A fishing tackle device comprising:
a body, wherein the body is a crankbait body;
a bill extending outwardly and forwardly from the crankbait body;
an attachment point located on the bill, the attachment point configured to connect to a fishing line; and
a sonar reflector on the crankbait body, the sonar reflector is configured to receive and direct sonar waves toward a transducer of a fish finder on a fishing platform from which the fishing line emanates.

20. A fishing tackle device comprising:
a lure configured to be pulled through the water toward a fishing platform by a fishing line from the fishing platform, wherein the lure comprises a sonar reflector configured to direct sonar waves emanating from the fishing platform back at the fishing platform.
